(19) United States
(12) Patent Application Publication
(10) Pub. No.: US 2020/0376937 A1
(43) Pub. Date: Dec. 3, 2020

(54) LIGHT-ADJUSTING SYSTEM AND VEHICLE LIGHT-ADJUSTING SYSTEM

(71) Applicant: TOYOTA BOSHOKU KABUSHIKI KAISHA, Alchi (JP)

(72) Inventors: Motoki MAEKAWA, Aichi (JP); Mitsutaka SAKO, Aichi (JP)

(73) Assignee: TOYOTA BOSHOKU KABUSHIKI KAISHA, Aichi (JP)

(21) Appl. No.: 16/881,423

(22) Filed: May 22, 2020

(30) Foreign Application Priority Data
May 29, 2019 (JP) 2019-099876
May 29, 2019 (JP) 2019-099880

(51) Int. Cl. B60J 3/04; B60N 2/00; G06F 3/01

(52) U.S. Cl. CPC B60J 3/04; G06F 3/013; B60N 2/002

(57) ABSTRACT

The light-adjusting system includes an interior sensor that detects interior data for grasping a state of an interior of the vehicle, an interior information acquiring unit that acquires information related to the state of the interior based on the interior data detected by the interior sensor, a determination unit that determines whether or not the interior is in an abnormal state based on the information acquired by the interior information acquiring unit, and an adjustment unit that adjusts the light transmittance of the window glass. When it is determined as the abnormal state where the light transmittance of the window glass has been adjusted such that it is difficult to visually recognize the interior through the window glass, the adjustment unit adjusts the light transmittance of the window glass to visually recognize the interior from outside the vehicle through the window glass.

### CROSS-REFERENCE TO RELATED APPLICATION

The present disclosure relates to a light-adjusting system and a vehicle light-adjusting system. This application is based on and claims the priority of Japanese Patent Application No. 2019-99880 filed on May 29, 2019 and Japanese Patent Application No. 2019-99876 filed on May 29, 2019, the entire contents of each of which are incorporated herein by reference.

### BACKGROUND OF THE INVENTION

### Regarding First Disclosure

Japanese Laid-Open Patent Publication No. 2012-188035 discloses a technology that gives an alarm for an abnormal state in a vehicle, for example, a state in which a child is abandoned. That is, in this technology, an alarm device includes a connection detecting unit that detects that the child seat is attached to the vehicle, an engine stop operation detecting unit, an alarm means that gives an alarm that a child is abandoned in the vehicle, and a door lock detecting unit of the door of the vehicle. In the alarm device, when an engine stop operation is detected, the alarm means issues an alarm in a case where the child seat is attached to the vehicle and the child seat belt is in a fastened state. Sounding a horn is exemplified as this alarm means, whereby an abnormal state is notified to the outside of the vehicle.

However, in a case of high emergency, notification by sound is not always sufficient, and a technology for notifying through a more effective method has been desired.

The first disclosure has been made in view of the above circumstances, and aims to effectively notify an abnormal state inside a vehicle to the outside of the vehicle.

### Regarding Second Disclosure

A vehicle light-adjusting system using a light-adjusting member that is attached to a window to control transmission of external light is known (see Japanese Laid-Open Patent Publication No. 2018-177193). The vehicle light-adjusting system includes a control-mode selecting unit that receives selection of a control mode that is a control target of a light-adjusting film, and a drive control unit that controls the transmittance of the light-adjusting film. The drive control unit adjusts the transmittance of the light-adjusting film based on the control mode selected by the control mode selecting unit.

However, the conventional vehicle light-adjusting system has the following problems. That is, since the system is a system that only controls the transmittance of the light-adjusting film, light-adjusting can be performed only during daylight hours in the day.

Furthermore, in the system, the brightness in the vehicle interior can be reduced by shielding the external light when the vehicle interior is too bright; however, the brightness in the vehicle interior cannot be increased when the vehicle interior is too dark.

The second disclosure has been made in view of the above circumstances, and aims to provide a vehicle light-adjusting system capable of adjusting the brightness in a vehicle interior day and night.

### SUMMARY OF THE INVENTION

### First Disclosure

A light-adjusting system of a vehicle including a window glass capable of adjusting light transmittance, the light-adjusting system including:

an interior sensor that detects interior data for grasping a state of an interior of the vehicle;

an interior information acquiring unit that acquires information related to the state of the interior based on the interior data detected by the interior sensor;

a determination unit that determines whether or not the interior is in an abnormal state based on the information acquired by the interior information acquiring unit; and

an adjustment unit that adjusts the light transmittance of the window glass.

In the light-adjusting system, when it is determined as the abnormal state by the determination unit in a case where the light transmittance of the window glass has been adjusted to a state in which the interior is difficult to visually recognize from outside the vehicle through the window glass, the adjustment unit adjusts the light transmittance of the window glass to a state in which the interior is easy to visually recognize from outside the vehicle through the window glass.

### Second Disclosure

A vehicle light-adjusting system including,

an incident portion which an external light enters;

a light-adjusting member arranged in the incident portion;

a light emitting unit provided in an interior of a vehicle; and

a control unit that controls transmittance of the light-adjusting member and controls illuminance of the light emitting unit.

According to the first disclosure, when it is determined that the inside is in an abnormal state in a case where the interior is difficult to visually recognize, the light transmittance of the window glass is adjusted so as to obtain a state in which the interior is easy to visually recognize. Thus, an abnormal state can be easily confirmed from the outside. That is, the light transmittance of the window glass is adjusted so that the interior becomes easy to visually recognize, and an abnormal state inside the vehicle is effectively notified to the outside of the vehicle.

According to the second disclosure, the illuminance of the light emitting unit is controlled while controlling the transmittance of the light-adjusting member. Thus, the brightness in the interior of the vehicle can be adjusted day and night.

### BRIEF DESCRIPTION OF THE DRAWINGS

FIG. 1 is a schematic view of a vehicle 3, on which a light-adjusting system 1 is mounted, as viewed from a side:

FIG. 2 is a schematic view of the vehicle 3, on which the light-adjusting system 1 is mounted, as viewed from vertically above;

FIG. 3 is a block diagram showing an overall configuration of the light-adjusting system 1;

FIG. 4 is an explanatory view showing a side window glass 5A;

FIG. 5 is an exploded perspective view showing a part 41 of a light-adjusting member 31;

FIG. 6 is an explanatory view showing a change in transmittance of the part 41 of the light-adjusting member 31;

FIG. 7 is a flowchart illustrating an example of a processing procedure of the light-adjusting system 1 according to a first embodiment:

FIG. 8 is an explanatory view showing an example of a state of the window glass 5 before an alarm (before an alert);

FIG. 9 is an explanatory view showing an example of a state of the window glass 5 at the time of the alarm (at the time of the alert);

FIG. 10 is an explanatory view showing another example of the state of the window glass 5 at the time of the alarm (at the time of the alert);

FIG. 11 is a schematic view of a vehicle 103, on which the vehicle light-adjusting system 101 is mounted, as viewed from vertically above;

FIG. 12 is a block diagram showing an overall configuration of a vehicle light-adjusting system 101;

FIG. 13 is an exploded perspective view showing a light-adjusting member 107:

FIG. 14 is a conceptual diagram showing a change in transmittance of the light-adjusting member 107:

FIG. 15 is a conceptual diagram showing an irradiation range 127; and

FIG. 16 is a flowchart illustrating an example of a processing procedure of the vehicle light-adjusting system 101.

### DETAILED DESCRIPTION

Here, a desirable example of the first disclosure will be described.

In the light-adjusting system, the window glass is subdivided into a plurality of areas and the light transmittance is adjustable for each of the areas. When it is determined as the abnormal state by the determination unit, the adjustment unit adjusts the light transmittance of the window glass so that a warning display including at least one of characters, graphics, and symbols is displayed on the window glass by adjusting the light transmittance of each of the areas.

According to this configuration, it is possible to effectively appeal the abnormal state to the outside.

In the light-adjusting system, the interior sensor includes at least an occupant sensor that detects occupant data for estimating a state of an occupant.

According to this configuration, an abnormality related to the occupant can be notified to the outside of the vehicle.

Here, a desirable example of the second disclosure will be described.

The vehicle light-adjusting system further includes an information acquiring unit that acquires information on a predetermined object in the interior. In the vehicle light-adjusting system, the control unit adjusts the transmittance of the light-adjusting member and adjusts the illuminance of the light emitting unit based on the information acquired by the information acquiring unit.

According to this configuration, the brightness can be adjusted based on the information on the predetermined object, so that more appropriate light-adjustment can be performed.

In the vehicle light-adjusting system, when a state of the predetermined object obtained from the information is determined to be caused by brightness of the interior being lower than a first threshold value defined in advance, the control unit controls the illuminance of the light emitting unit to be higher than a current state, and when a state of the predetermined object obtained from the information is determined to be caused by brightness of the interior being higher than a second threshold value defined in advance, the control unit controls the transmittance of the light-adjusting member to be lower than a current state.

According to this configuration, the brightness is controlled so that the state of the predetermined object becomes more desirable.

In the vehicle light-adjusting system, the information is at least one selected from a group consisting of brightness of the predetermined object, temperature of the predetermined object, number of blinks, and diameter of a pupil of an eye.

According to this configuration, the brightness is controlled so that the brightness of the predetermined object, the temperature of the predetermined object, the number of blinks, and the diameter of the pupil of the eye become more desirable. As a result, the occupant can spend a more comfortable time.

In the vehicle light-adjusting system, the predetermined object is a plurality of occupants. The information acquiring unit acquires individual information on each of the occupants. The control unit adjusts the transmittance of the light-adjusting member and adjusts the illuminance of the light emitting unit so that brightness of an individual predetermined area of the occupant becomes a predetermined illuminance.

According to this configuration, the brightness can be optimized for each occupant.

### Regarding First Disclosure

### First Embodiment

A first embodiment of a vehicle 3 including a light-adjusting system 1 will be described in detail with reference to the drawings.

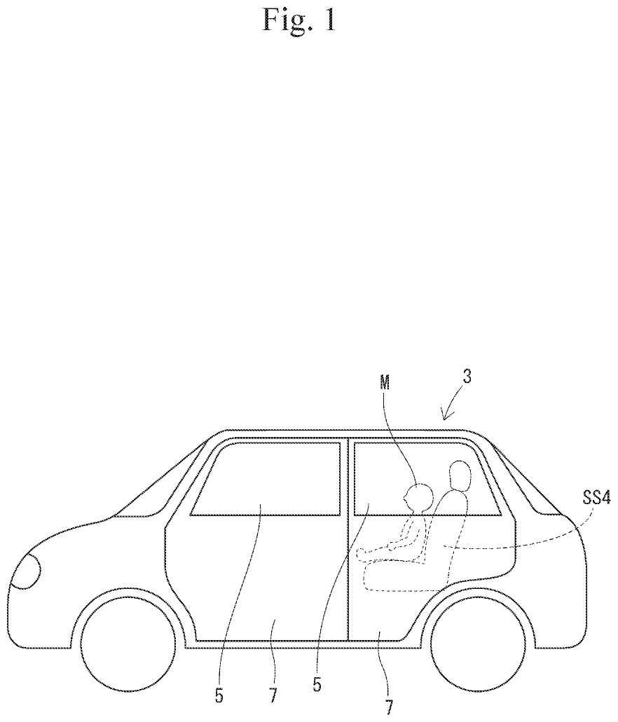

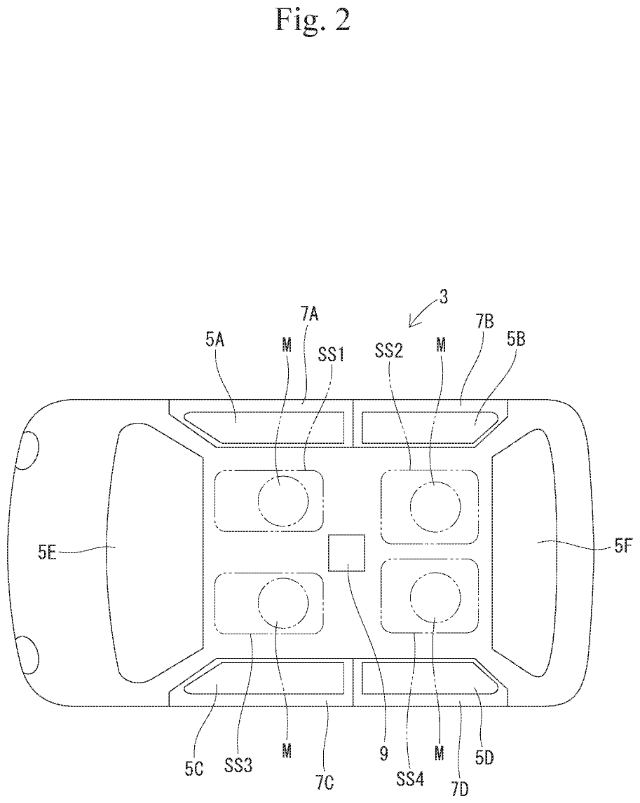

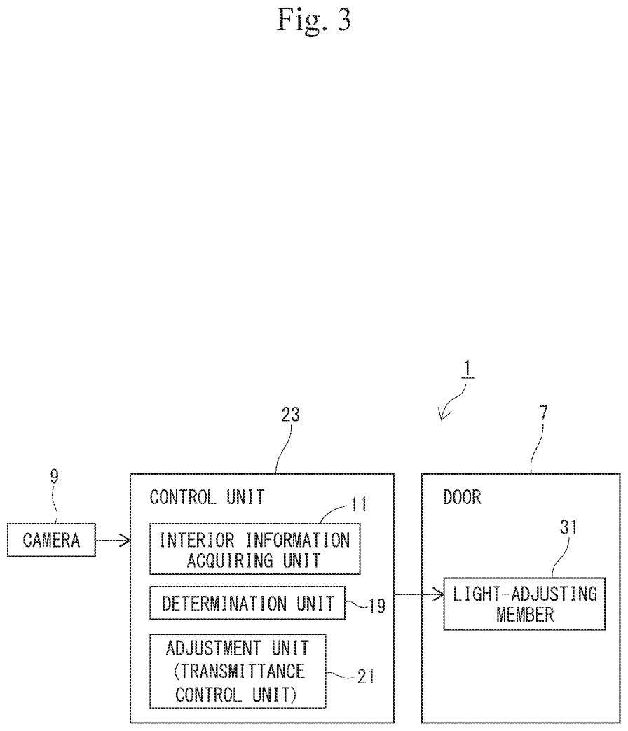

FIG. 1 is a schematic view of a vehicle 3, on which a light-adjusting system 1 is mounted, as viewed from a side. FIG. 2 is a schematic view of the vehicle 3, on which the light-adjusting system 1 is mounted, as viewed from vertically above. FIG. 3 is a block diagram showing an overall configuration of the light-adjusting system 1.

The vehicle 3 has a window glass 5 in which light transmittance can be adjusted. The light-adjusting system 1 includes a camera 9 serving as an interior sensor, an interior information acquiring unit 11, a determination unit 19, and an adjustment unit 21. The camera 9 detects interior data for grasping the state of the interior of the vehicle 3. The interior information acquiring unit 11 acquires information on the state of the interior based on the interior data detected by the camera 9. The determination unit 19 determines whether or not the interior is in an abnormal state based on the information acquired by the interior information acquiring unit 11. The adjustment unit 21 adjusts the transmittance of the window glass 5. The adjustment unit 21 is configured to be able to change the transmittance of light (visible light) by, for example, performing voltage control, and functions as a transmittance control unit.

The light-adjusting system 1 functions as follows in a case where the light transmittance of the window glass 5 has adjusted to a state in which the interior is difficult to visually recognize from the outside of the vehicle 3 through the window glass 5. That is, in the light-adjusting system 1, when it is determined as the abnormal state by the determination unit 19, the adjustment unit 21 adjusts the light transmittance of the window glass 5 to a state in which the interior is easy to visually recognize from the outside of the vehicle 3 through the window glass 5.

The interior information acquiring unit 11, the determination unit 19, and the adjustment unit 21 are provided in the control unit 23. The control unit 23 (ECU (Electronic Control Unit)) includes a CPU (Central Processing Unit) and a memory (e.g., ROM (Read Only Memory), RAM (Random Access Memory), etc.).

The vehicle 3 has seats SS1, SS2, SS3, and SS4. The seat SS1 is a driver's seat.

A door 7 is, specifically, a front door 7A on the driver's seat side, a rear-door 7B on the driver's seat side, a front door 7C on a passenger's seat side, and a rear door 7D on the passenger's seat side. Each of the doors 7 is a so-called swing type door that opens toward an outer side in a width direction of the vehicle 3 by a hinge (not shown).

The front door 7A on the driver's seat side is provided with a side window glass 5A, and the rear door 7B on the driver's seat side is provided with a side window glass 5B. The front door 7C on the passenger's seat side is provided with a side window glass 5C, and the rear door 7D on the passenger's seat side is provided with a side window glass 5D.

The vehicle 3 includes a front window glass 5E and a rear window glass 5F as other window glasses 5.

The light transmittance of each of the window glasses 5 can be adjusted by a light-adjusting member 31. That is, the light-adjusting member 31 is arranged over substantially the entire surface of the side window glass 5A, the side window glass 5B, the side window glass 5C, the side window glass 5D, the front window glass 5E, and the rear window glass 5F.

More specifically, the side window glass 5A, the side window glass 5B, the side window glass 5C, the side window glass 5D, the front window glass 5E, and the rear window glass 5F each has the light-adjusting member 31 attached from the vehicle interior side to a glass plate (which may be either inorganic glass or organic glass) serving as a transparent plate material. The light-adjusting member 31 may be attached from the exterior side of the vehicle, or may be sandwiched between the glass plates of the laminated glass of each window glass 5 by way of an intermediate film.

The light-adjusting members 31 arranged in the side window glass 5A, the side window glass 5B, the side window glass 5C, the side window glass 5D, the front window glass 5E, and the rear window glass 5F are each divided into a plurality of parts 41. Here, the light-adjusting member 31A arranged in the side window glass 5A will be specifically described. The same applies to the structures of the other glasses, the side window glass 5B, the side window glass 5C, the side window glass 5D, the front window glass 5E, and the rear window glass 5F.

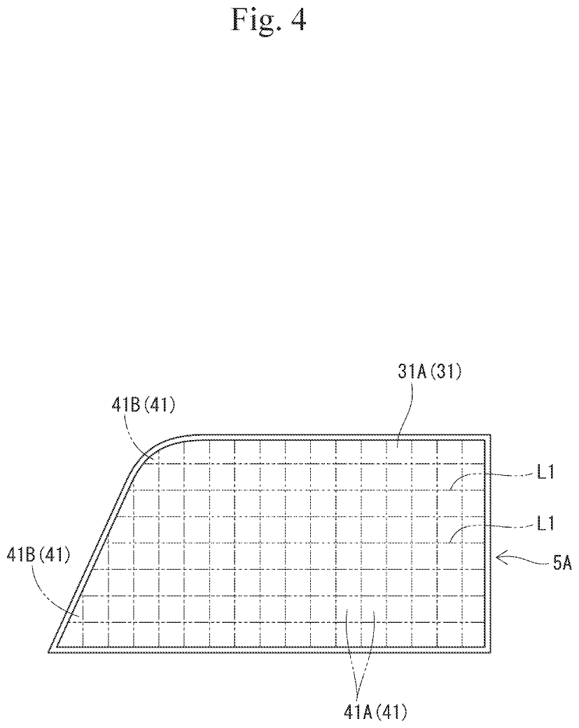

FIG. 4 schematically shows the light-adjusting member 31A arranged in the side window glass 5A.

The light-adjusting member 31A is subdivided and divided into a plurality of parts 41. Specifically, the light-adjusting member 31A is divided into a plurality of parts 41 by, for example, a plurality of lines L1 arranged along the horizontal direction and a plurality of intersecting lines L2 intersecting the plurality of lines L1. Inside an outer edge portion of the light-adjusting member 31A, the parts 41 are rectangular parts 41A having the same area. In the outer edge portion of the light-adjusting member 31A, not only rectangular but also triangular or trapezoidal parts 41B are present.

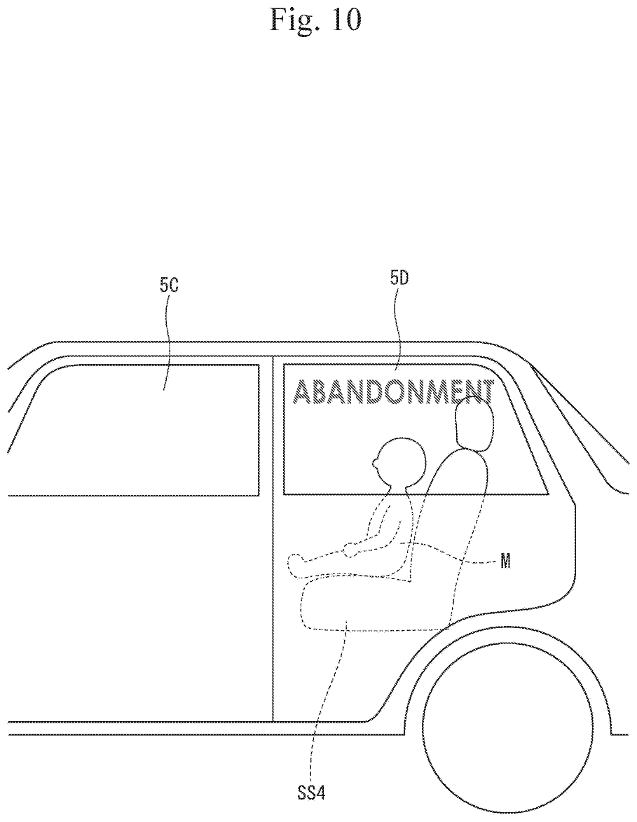

The adjustment unit 21 is configured to be able to individually adjust the transmittance of each part 41. A predetermined character, figure, symbol, and the like are displayed by individually adjusting the transmittance of each part 41 based on a predetermined pattern. For example, the adjustment unit 21 can display characters, figures, and symbols made by a set of non-transmitting parts by setting a plurality of parts 41 constituting characters, figures, and symbols as non-transmitting parts, and setting the surrounding parts thereof as transmitting parts (see “ABANDONMENT” in FIG. 10). Alternatively, the adjustment unit 21 can display characters, figures, and symbols made by a set of transmitting parts by setting a plurality of parts 41 constituting characters, figures, and symbols as transmitting parts and setting surrounding parts thereof as non-transmitting parts.

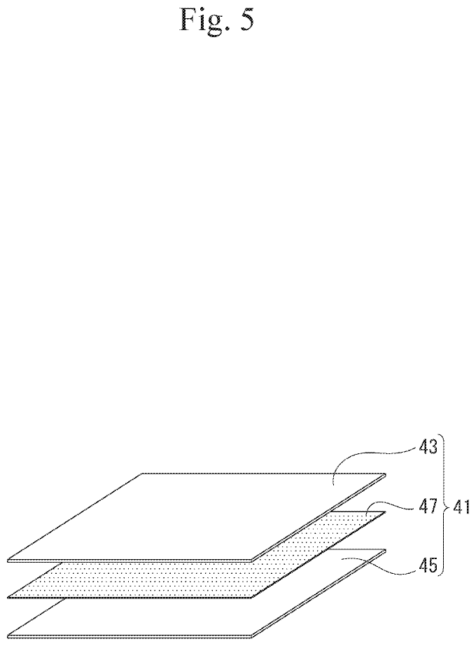

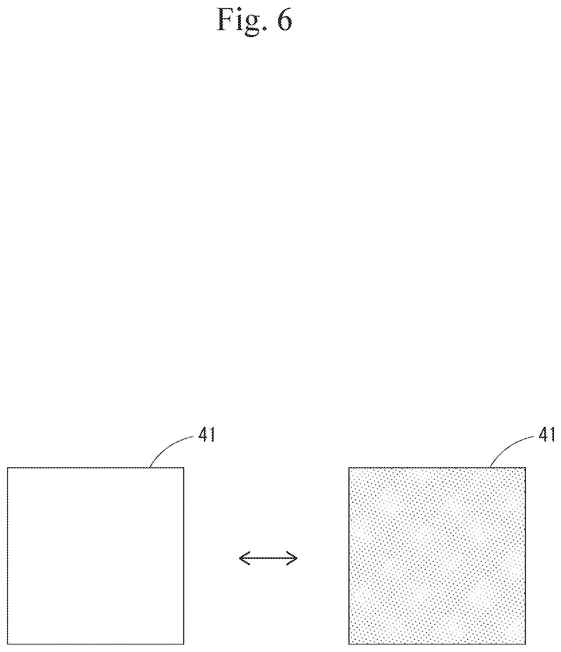

As shown in FIG. 5, in each part 41 of the light-adjusting member 31, a light-adjusting film 47 is disposed between a first electrode 43 and a second electrode 45, and the transmittance is changed by a voltage applied in between the first electrode 43 and the second electrode 45. For example, each part 41 becomes transparent or high transmittance when voltage is applied as shown in the left figure of FIG. 6, and becomes opaque or low transmittance when no voltage is applied as shown in the right figure of FIG. 6.

As the light-adjusting film 47, there is suitably exemplified (1) a light-adjusting film 47 using an EC (Electro Chromic) method, (2) a light-adjusting film 47 using an SPD (Suspended Particle Device) method, (3) a light-adjusting film 47 using liquid crystals of VA (Vertical Alignment) method, TN (Twisted Nematic) method or IPS (In-Place-Switching) method.

The light-adjusting film 47 using the EC method has a structure in which a light-adjusting layer (electrolyte layer) is sandwiched between a pair of electrodes. The color of the light-adjusting layer changes between transparent and dark blue according to the potential difference between the electrodes using the oxidation-reduction reaction.

The light-adjusting film 47 using the SPD method is usually colored dark blue using the orientation of fine particles, but changes to transparent when voltage is applied, and returns to the original dark blue when the voltage is turned off. Thus, light and shade can be adjusted by the voltage.

Further, as the light-adjusting film 47, a light-adjusting film 47 using a PDLC (Polymer Dispersed Liquid Crystal) method may be used. The light-adjusting film 47 using the PDLC method has a network structure made of a special polymer formed in the liquid crystal layer, wherein a state in which an array of liquid crystal molecules is irregular is induced by the action of the polymer network, so that light is scattered. When a voltage is applied to array the liquid crystal molecules in the direction of the electric field, light is not scattered so that a transparent state is obtained.

The camera 9 is a sensor that detects data for estimating the state of the occupant M. Any type of camera can be adopted as the camera 9. For example, one or more types selected from a group consisting of a monocular camera, a stereo camera, a visible light camera, an infrared camera, and a TOF distance image camera is suitably adopted. The camera 9 photographs the occupant M. The installing position and the installing number of the cameras 9 are not particularly limited.

The interior information acquiring unit 11 estimates the state of the occupant M based on the data detected by the camera 9 for estimating the state of the occupant M, and acquires the state information of the occupant M. For example, if data indicating that the amount of activity of the occupant M is small and there is no motion during a predetermined period is detected, it is estimated that the occupant M is in an unconscious state, and the state information “occupant unconscious” is acquired. When data indicating that there is no pulse wave of the occupant M is detected, it is estimated that the occupant M is in an unconscious state, and the state information “occupant unconscious” is acquired. When data indicating that a child is left alone and no adult is present in the vehicle interior for a predetermined period is detected, it is estimated that the child is in an abandoned state, and the state information “abandonment” is acquired.

The interior information acquiring unit 11 transmits the acquired state information of the occupant M to the determination unit 19.

The determination unit 19 determines whether or not the inside is in an abnormal state based on the state information of the occupant M transmitted from the interior information acquiring unit 11. For example, when the state information of the occupant M transmitted from the interior information acquiring unit 11 includes any of the information of “occupant unconscious” and “abandonment”, the vehicle interior is determined to be in an abnormal state.

Furthermore, the determination unit 19 determines whether or not the light transmittance (light transmittance of visible light) of the window glass 5 is adjusted to a state where the interior of the vehicle is difficult to visually recognize from the outside of the vehicle 3 through the window glass 5. A case where the light transmittance of the window glass 5 is adjusted in this manner is, for example, a case where the interior is made difficult to visually recognize through the window glass 5 from the viewpoint of privacy protection while the vehicle 3 is stopped. More specifically, this is a case where the light transmittance of each part 41 is 30% or less.

When the light transmittance of the window glass 5 has been adjusted to a state in which the interior is difficult to visually recognize from the outside of the vehicle 3 through the window glass 5 and the inside is in an abnormal state, the determination unit 19 notifies the adjustment unit 21 the determination result indicating that an alarm is necessary.

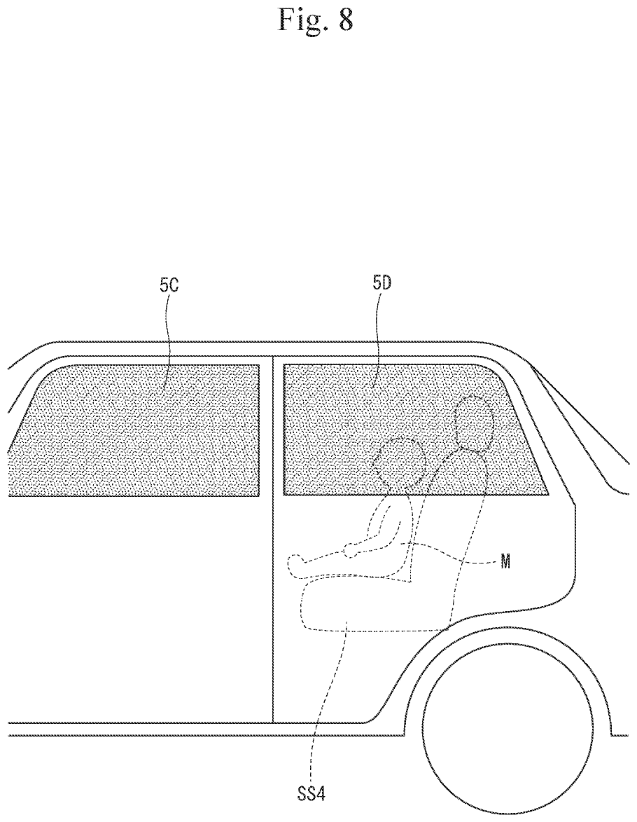

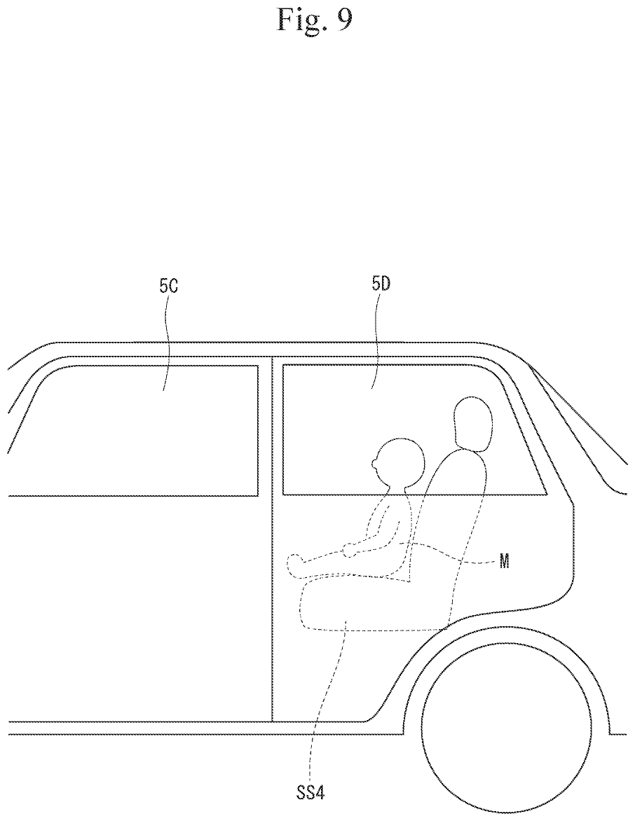

When the adjustment unit 21 receives the determination result indicating that an alarm is necessary from the determination unit 19, the adjustment unit 21 adjusts the light transmittance of the window glass 5 to a state in which the interior is easy to visually recognize from the outside of the vehicle 3 through the window glass 5. For example, the adjustment unit 21 adjusts the light transmittance of the window glass 5 from the state of FIG. 8 to the state of FIG. 9. More specifically, the light transmittance of each part 41 is adjusted to 70% or more.

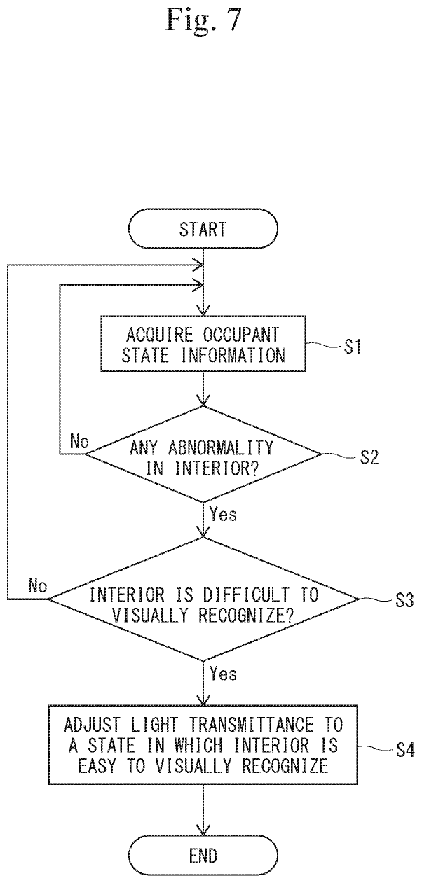

FIG. 7 is a flowchart illustrating an example of a processing procedure of the light-adjusting system 1. This operation program is stored in a ROM or the like in the control unit 23, and is executed by the CPU.

In step S1, the interior information acquiring unit 11 acquires the state information of the occupant M. and transmits the acquired state information of the occupant M to the determination unit 19.

In step S2, the determination unit 19 determines whether or not the state information of the occupant M includes any of the abnormal information such as “occupant unconscious” and “abandonment”. When the abnormal information is included, the process proceeds to step S3. When the abnormal information is not included, the process returns to step S1.

In step S3, the determination unit 19 determines whether or not the light transmittance of the window glass 5 has been adjusted to a state in which the interior is difficult to visually recognize from the outside of the vehicle 3 through the window glass 5. When the light transmittance of the window glass 5 has been adjusted (e.g., in the case of FIG. 8) to a state in which the interior is difficult to visually recognize, the process proceeds to step S4. When the light transmittance of the window glass 5 has been adjusted to a state in which the interior is easy to visually recognize, the process returns to step S1.

In step S4, the adjustment unit 21 adjusts the light transmittance of the window glass 5 to a state in which the interior of the vehicle is easy to visually recognize from the outside of the vehicle 3 through the window glass 5 (see FIG. 9). That is, the adjustment unit 21 increases the light transmittance of the window glass 5 to obtain a transparent state. At this time, the adjustment unit 21 increases the light transmittance and obtains transparency of one or more window glasses 5 selected from a group consisting of the side window glass 5A, the side window glass 5B, the side window glass 5C, the side window glass 5D, the front window glass 5E, and the rear window glass 5F. In order to effectively inform the abnormal state to the outside, it is preferable to increase the light transmittance of all window glasses 5 to make them transparent.

As described above, in the light-adjusting system 1, when it is determined that the inside is in an abnormal state in a case where the interior is difficult to visually recognize, the light transmittance of the window glass 5 is adjusted so that the interior becomes easy to visually recognize. Therefore, an abnormal state can be easily confirmed from the outside. That is, the light transmittance of the window glass 5 is adjusted so that the interior becomes easy to visually recognize, and an abnormal state of the interior of the vehicle 3 is effectively notified to the outside of the vehicle 3.

Furthermore, in the light-adjusting system 1, the camera 9 is used as an interior sensor, and the state of the occupant M is estimated based on an image detected by the camera 9 and the abnormal state of the occupant M is detected. Therefore, in the present configuration, an abnormal state regarding the occupant M with high emergency can be notified to the outside of the vehicle.

The foregoing examples are merely for illustrative purposes and are not to be construed as limiting the present disclosure. Although the present disclosure has been described with reference to exemplary embodiments, it is to be understood that the language used in the description and the illustration of the present disclosure is descriptive and illustrative and not restrictive. Asset forth herein, modifications may be made within the scope of the appended Claims without deviating from the scope or essence of the present disclosure in its form. Although reference has been made herein to specific structures, materials and examples in the detailed description of the present disclosure, it is not intended to limit the present disclosure to the disclosed matters herein, but rather the present disclosure is to cover all functionally equivalent structures, methods, and uses within the scope of the appended Claims.

The first disclosure is not limited to the embodiment described in detail above, and various modifications or changes can be made within the scope defined in the Claims.

(1) In the embodiment described above, an example in which the camera 9 is used as an interior sensor has been described, but a wide variety of sensor s can be used as an interior sensor as long as it can grasp the state of the vehicle interior. An interior sensor may be, for example, a microphone, a pressure sensor of a seat, a seating sensor, a sensor that measures the heart rate of the occupant M, a sensor that measures the blood pressure of the occupant M, a sensor that measures the perspiration amount of the occupant M, a sensor that measures the body temperature of the occupant M, or the like. For example, the voice of the occupant M may be detected and recognized by a microphone, and the situation of the vehicle interior may be grasped by the voice or the like uttered by the occupant M. More specifically, when the voice of the occupant M is crying or screaming, or when a word seeking for help is uttered, an abnormal state inside the vehicle 3 may be notified to the outside of the vehicle 3.

Furthermore, a plurality of types of sensors may be used as an interior sensor. The number of interior sensors is not particularly limited.

(2) In the embodiment described above, the light transmittance of the entire surface of the window glass 5 is increased to make it transparent, as shown in FIG. 9, when the inside is in an abnormal state. However, as shown in FIG. 10, a part of the window glass 5 may be set to have light transmittance of an opaque state so that a warning display including at least one of characters, graphics, and symbols is displayed by such an opaque portion. Thus, the abnormal state can be effectively appealed to the outside of the vehicle 3. As a character, it is preferable to use one that means an abnormal state of the interior. As a figure, it is preferable to use one that is related to an abnormal state of the interior. As a symbol, it is preferable to use one that is related to an abnormal state of the interior.

The warning display may be colored. Examples of the colors include red, blue, and white. Thus, the effect of notifying the abnormal state is enhanced.

(3) A car (automobile) is exemplified as the vehicle 3, but the light-adjusting system 1 may be applied to other vehicles, such as a train or a game vehicle serving as a ground vehicle, an airplane or a helicopter serving as a flying vehicle, a ship or a submarine serving as a marine or an underwater vehicle.

(4) In the embodiment described above, the abnormal state is notified to the outside of the vehicle 3 by adjusting the light transmittance of the window glass 5 so that the interior is easy to visually recognize. However, it may be notified in combination with sound or light (various lamps (room light, hazard lamps, etc.).

### Regarding Second Disclosure

An embodiment of a vehicle 103 including a vehicle light-adjusting system 101 of the second disclosure will be described in detail with reference to the drawings.

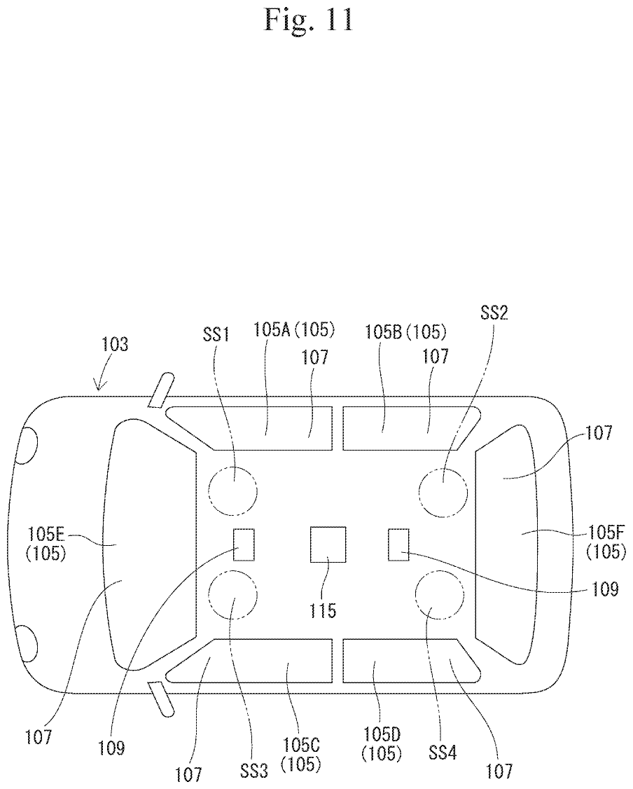

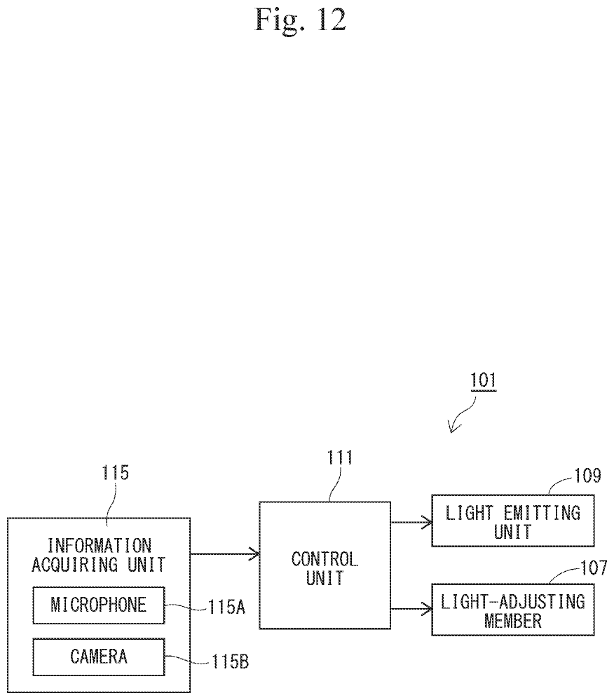

FIG. 11 is a schematic view of a vehicle 103 on which a vehicle light-adjusting system 101 is mounted, as viewed from vertically above. FIG. 12 is a block diagram showing an overall configuration of the vehicle light-adjusting system 101.

The vehicle light-adjusting system 101 includes an incident portion 105 which external light enters, a light-adjusting member 107 arranged in the incident portion 105, a light emitting unit 109 provided in an interior of the vehicle 103, and a control unit 111 (ECU (Electronic Control Unit)). The control unit 111 includes a CPU (Central Processing Unit), a memory (e.g., a ROM (Read Only Memory), a RAM (Random Access Memory)), and the like. The control unit 111 controls the transmittance of the light-adjusting member 107 and controls the illuminance of the light emitting unit 109. The vehicle light-adjusting system 101 includes an information acquiring unit 115 that acquires information on a predetermined object in the interior. The control unit 111 is capable of communicating information with the information acquiring unit 115 in a wired or wireless manner. The control unit 111 is capable of communicating information with the light-adjusting member 107 and the light emitting unit 109 in a wired or wireless manner.

Although illustration is omitted, the system may also include an operation input unit such as an operation key and an operation button for receiving an operation from an occupant such as a driver.

The vehicle 103 is provided with seats SS1, SS2, SS3, and SS4. The seat SS1 is a driver's seat. The occupant in the seat SS1 is a driver of the vehicle 103. The incident portion 105 which the external light enters is, specifically, a front-seat side-window 105A on the driver's seat side, a rear-seat side-window 105B on the driver's seat side, a front-seat side-window 105C on a passenger's seat side, a rear-seat side-window 105D on the passenger's seat side, a front window 105E, and a rear window 105F. A roof window (not shown) may be further provided as the incident portion 105.

The light-adjusting member 107 is arranged on substantially the entire surface of the front-seat side-window 105A, the rear-seat side-window 105B, the front-seat side-window 105C, the rear-seat side-window 105D, the front window 105E, and the rear window 105F.

More specifically, the light-adjusting member 107 is attached from the vehicle interior side to a glass plate, which is an example of a transparent plate material constituting the front-seat side-window 105A, the rear-seat side-window 105B, the front-seat side-window 105C, the rear-seat side-window 105D, the front window 105E, and the rear window 105F. The light-adjusting member 107 may be attached from the vehicle exterior side, or may be sandwiched between glass plates of laminated glass of each window by way of an intermediate film.

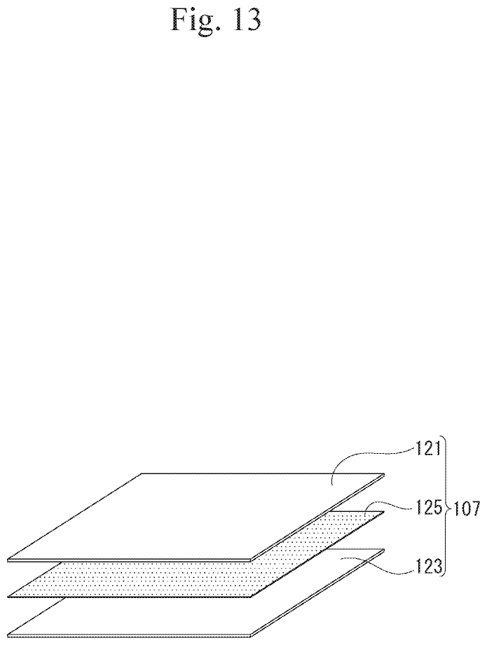

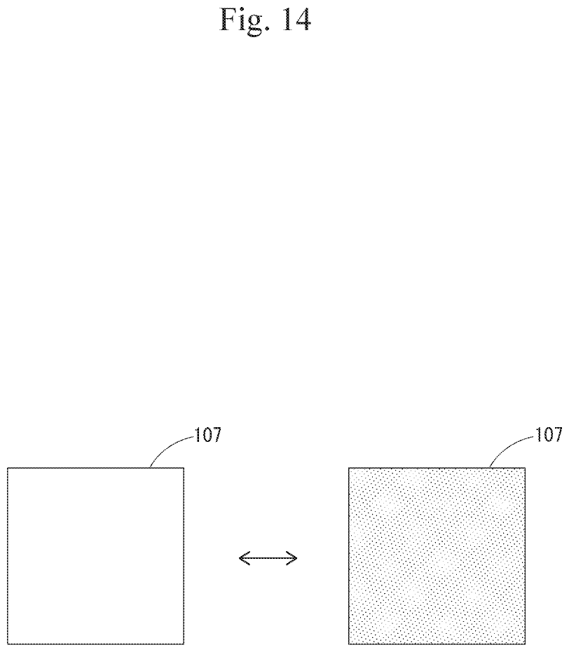

As shown in FIG. 13, in the light-adjusting member 107, a light-adjusting film 125 is disposed between a first electrode 121 and a second electrode 123, and the transmittance is changed by a voltage applied in between the first electrode 121 and the second electrode 123. For example, the light-adjusting member 107 becomes transparent or high transmittance when voltage is applied as shown in the left figure of FIG. 14, and becomes opaque or low transmittance when no voltage is applied as shown in the right figure of FIG. 14.

As the light-adjusting film 125, there is suitably exemplified (1) a light-adjusting film 125 using an EC (Electro Chromic) method, (2) a light-adjusting film 125 using an SPD (Suspended Particle Device) method, (3) a light-adjusting film 125 using liquid crystals of VA (Vertical Alignment) method, TN (Twisted Nematic) method or IPS (In-Place-Switching) method.

The light-adjusting film 125 using the EC method has a structure in which a light-adjusting layer (electrolyte layer) is sandwiched between a pair of electrodes. The color of the light-adjusting layer changes between transparent and dark blue according to the potential difference between the electrodes using the oxidation-reduction reaction.

The light-adjusting film 125 using the SPD method is usually colored dark blue using the orientation of fine particles, but changes to transparent when voltage is applied, and returns to the original dark blue when the voltage is turned off. Thus, light and shade can be adjusted by the voltage.

Further, the light-adjusting film 125 using a PDLC (Polymer Dispersed Liquid Crystal) method may be used. The light-adjusting film 125 using the PDLC method has a network structure made of a special polymer formed in the liquid crystal layer, wherein a state in which an array of liquid crystal molecules is irregular is induced by the action of the polymer network, so that light is scattered. When a voltage is applied to array the liquid crystal molecules in the direction of the electric field, light is not scattered so that a transparent state is obtained.

The information acquiring unit 115 is constituted of a sensor group including various sensors that acquire information on a predetermined object. Examples of the predetermined object include an occupant and various members in the interior. Although the information is not particularly limited, the brightness of the predetermined object, the temperature of the predetermined object, the number of blinks, and the diameter of the pupil of the eye are preferably exemplified.

The sensor group includes a microphone 115A for recognizing voice, a camera 115B for acquiring image information of the interior, and the like. The microphone 115A has a function of identifying and acquiring an individual voice of each occupant. The camera 115B is configured to be capable of sensing the state of the object.

The control unit 111 performs a control of performing calculations based on input data such as voice information acquired by the microphone 115A and image information acquired by the camera 115B and adjusting the transmittance of the light-adjusting member 107 and adjusting the illuminance and the irradiation range 127 of the light emitting unit 109. The RAM (arithmetic region) is a region for saving temporary calculation data in the control unit 111.

The light emitting unit 109 is a light emitting unit including a light source capable of adjusting the light color, illuminance, color temperature, contrast, and irradiation range 127 of emission light, and is used for illumination and the like of a vehicle interior. The number of light emitting units 109 is not particularly limited, and may be one or two or more.

The light emitting unit 109 can emit light of the following light colors in addition to visible light (e.g., wavelength of 380 nm to 750 nm). Examples of the light colors are, a light color (purple) belonging to a wavelength of 380 nm to 450 nm, a light color (blue) belonging to a wavelength of 450 nm to 495 nm, a light color (green) belonging to a wavelength of 490 nm to 570 nm, a light color (yellow) belonging to a wavelength of 570 nm to 590 nm, a light color (orange) belonging to a wavelength of 590 nm to 620 nm, and a light color (red) belonging to a wavelength of 620 nm to 750 nm.

The illuminance of emission light adjusted by the light emitting unit 109 is a physical quantity representing the brightness of light illuminating the surface of a physical body, and is expressed in lux. For example, the adjustment is performed stepwise by each physical quantity in a range from relatively bright high illuminance (high lux) to dark low illuminance (low lux).

The color temperature of emission light adjusted in the light emitting unit 109 is a scale representing the color of light emitted from the light source by a quantitative numerical value, and is expressed in thermodynamic temperature K (Kelvin). It is adjusted in some types, for example, from a relatively warm bulb color to warm white, white, day white, daylight color, and the like.

The contrast adjusted in the light emitting unit 109 is a contrast ratio in illumination, and is adjusted stepwise by each numerical value, for example, from a high contrast in which light and dark is relatively clear to a low contrast in which light and dark is not clear.

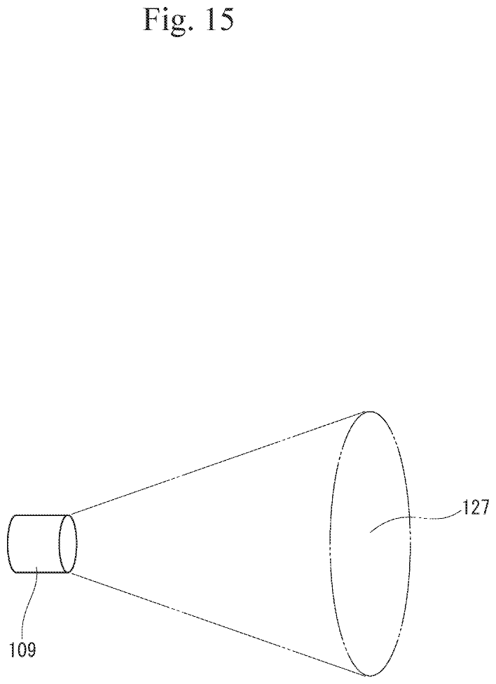

The irradiation range 127 (irradiation area) adjusted in the light emitting unit 109 refers to a range irradiated with light by the light emitting unit 109, as shown in FIG. 15. The irradiation range 127 is adjusted stepwise from a narrow area such as a spotlight to a wide area in which light spreads over a wide range. For example, the irradiation range 127 can be adjusted to be wide at the time of eating. A spotlight that irradiates only a periphery of a book can be adopted at the time of reading.

As the light emitting unit 109, for example, an LED or the like can be used in which the light color, the illuminance, the color temperature, the contrast, and the irradiation range 127 can be adjusted within a certain range. Furthermore, the light emitting unit 109 may be configured to include a plurality of light sources having different light emitting colors and driving means therefor. As a specific example, each light source can be an LED element whose light emitting color is red, green, or blue. When the light emitting unit 109 includes a plurality of light sources having different light emitting colors, the light colors can be changed by the mixing ratio of the light sources.

In the light emitting unit 109, the driving means of the light source can be configured to drive each light source based on a light emission control signal that is sent from the control unit 111 to give the instruction of light color, illuminance, color temperature, and contrast of the emission light for the light source. The driving method is not particularly limited, and for example, a PWM (pulse width modulation) method can be adopted. When a PWM signal is used, the driving power of each light source can be controlled by its frequency and duty ratio. The driving means may have a function of correcting the supply power to each light source so as to obtain a desired light color, illuminance, color temperature, contrast, and irradiation range 127 depending on the type, structure, characteristics, and the like of the light source to use.

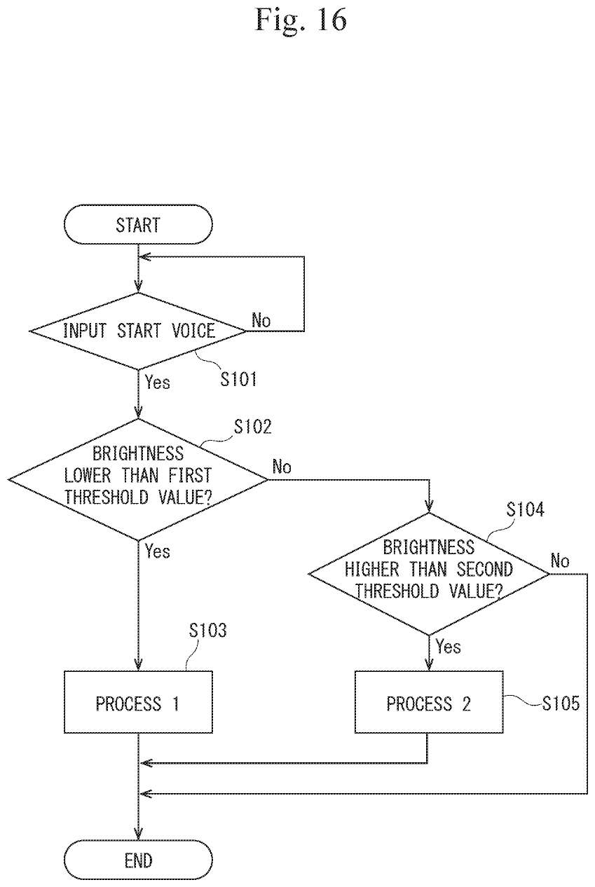

FIG. 16 is a flowchart illustrating an example of a processing procedure of the vehicle light-adjusting system 101. This operation program is stored in the ROM in the control unit 111, and is executed by the CPU.

When determined that the voice input from the microphone 115A is an instruction to start the vehicle light-adjusting system 101 (step S101: YES), the vehicle light-adjusting system 101 is started.

The control unit 111 adjusts the transmittance of the light-adjusting member 107 and adjusts the illuminance of the light emitting unit 109 based on the information acquired by the camera 115B.

Specifically, the transmittance of the light-adjusting member 107 and the illuminance of the light emitting unit 109 are adjusted as follows. First, the control unit 111 determines whether or not the brightness of the interior is lower than a predetermined first threshold value (lower limit value) from information (hereinafter also referred to as “predetermined information”) acquired by the camera 115B such as the temperature of the occupant's face, the brightness of the occupant's face, the number of blinks of the occupant's eyes, the diameter of the pupil of the occupant's eyes, and the like (step S102).

When determining that the brightness of the interior is lower than the first threshold value from the predetermined information (step S102: YES), the control unit 111 performs process 1 for increasing the illuminance of the light emitting unit 109 to be higher than the current state (step S103). Switching the light emitting unit 109 from the off state to the on state is included in “the process 1 for increasing the illuminance of the light emitting unit 109 to be higher than the current state” since it increases the illuminance from 0.

On the other hand, when determining that the brightness of the interior is equal to or greater than the first threshold value from the predetermined information (step S102: NO), the control unit 111 determines whether or not the brightness of the interior is higher than a predetermined second threshold value (upper limit value) from the predetermined information (step S104). When determining that the brightness of the interior is higher than the second threshold value from the predetermined information (step S104: YES), the control unit 11 performs process 2 for reducing the transmittance of the light-adjusting member 107 to be lower than the current state (step S105).

The magnitude relationship between the first threshold value and the second threshold value is such that first threshold value <second threshold value. The first threshold value and the second threshold value may be arbitrarily set by the occupant.

When a plurality of occupants are on board, the camera 115B may acquire the individual information of each of the occupants, and the control unit 111 may adjust the transmittance of the light-adjusting member 107 and adjust the illuminance of the light emitting unit 109 so that the brightness of the individual predetermined area of the occupant becomes a predetermined illuminance. Such adjustment can be realized by, for example, individually adjusting the transmittance of the front-seat side-window 105A, the rear-seat side-window 105B, the front-seat side-window 105C, the rear-seat side-window 105D on the assistant driver side, the front window 105E, and the rear window 105F, installing a plurality of light emitting units 109, and individually adjusting the illuminance of each light emitting unit 109. Here, the individual predetermined area of the occupant is, for example, a face, hands, feet, and the like.

As described above, the vehicle light-adjusting system 101 controls the illuminance of the light emitting unit 109 while controlling the transmittance of the light-adjusting member 107, and thus can adjust the brightness in the interior of the vehicle 103 day and night.

The vehicle light-adjusting system 101 can also perform a more appropriate light-adjusting as the brightness is adjusted based on the information of the occupant.

Furthermore, when the state of the occupant is determined to be caused by the brightness of the interior being lower than a predetermined first threshold value and being dark, the control unit 111 controls the illuminance of the light emitting unit 109 to be higher than the current state. For example, when the occupant tries to perform a desired action such as eating, reading, and the like, but the visibility is poor and it is difficult for the occupant to perform the action because the interior is too dark, the illuminance of the light emitting unit 9 is increased to be higher than the current state so that the occupant can perform the action comfortably.

On the other hand, when the state of the occupant is determined to be caused by the brightness of the interior being higher than a predetermined second threshold value and being too bright, the control unit 111 controls the transmittance of the light-adjusting member 107 to be lower than the current state. For example, in a case where the interior is too bright and the number of blinks of the occupant is large, or in a case where the external light is too strong and the temperature of the occupant is high, the transmittance of the light-adjusting member 107 is reduced from the current state, so that the occupant can spend a comfortable time.

When the information is at least one selected from the group consisting of the brightness of the predetermined object, the temperature of the predetermined object, the number of blinks, and the diameter of the pupil of the eye, the brightness can be controlled so that these parameters become more desirable, and thus the occupant can spend more comfortable time.

When a plurality of occupants are on board, the camera 115B acquires the individual information of each of the occupants, and the control unit 111 adjusts the transmittance of the light-adjusting member 107 and adjusts the illuminance of the light emitting unit 109 so that the brightness of the individual predetermined area of the occupant becomes a predetermined illuminance. Therefore, the brightness can be optimized for each occupant.

The foregoing examples are merely for illustrative purposes and are not to be construed as limiting the second disclosure. Although the present disclosure has been described with reference to exemplary embodiments, it is to be understood that the language used in the description and the illustration of the present disclosure is descriptive and illustrative and not restrictive. As set forth herein, modifications may be made within the scope of the appended Claims without deviating from the scope or essence of the present disclosure in its form. Although reference has been made herein to specific structures, materials and examples in the detailed description of the present disclosure, it is not intended to limit the present disclosure to the disclosed matters herein, but rather the present disclosure is to cover all functionally equivalent structures, methods, and uses within the scope of the appended Claims.

The second disclosure is not limited to the embodiment described in detail above, and various modifications or changes can be made within the scope defined in the Claims.

(1) In the embodiment described above, a car (automobile) is exemplified as the vehicle 103, but the vehicle light-adjusting system 101 may be applied to other vehicles, such as a train or a game vehicle serving as a ground vehicle, an airplane or a helicopter serving as a flying vehicle, a ship or a submarine serving as a marine or an underwater vehicle.

(2) In the embodiment described above, the example in which the information acquiring unit 115 constituted of the sensor group is arranged on the ceiling surface of the vehicle 103 has been described, but the installing location of the information acquiring unit 115 is not particularly limited. Furthermore, sensors may be respectively arranged at different locations.

(3) In the embodiment described above, the example in which the light emitting unit 109 is arranged on the ceiling surface of the vehicle 103 has been described, but the installing location of the light emitting unit 109 is not particularly limited.

(4) In the embodiment described above, the example in which the number of the light emitting units 109 is two has been described, but the number of the light emitting units 109 can be appropriately changed.

(5) In the embodiment described above, the example in which the predetermined object is an occupant has been described, but the predetermined object can be appropriately changed. For example, the predetermined object may be an interior component such as a seat or a floor.

(6) In the embodiment described above, the vehicle light-adjusting system 101 is started by the voice input from the microphone 115A, but the method of starting the vehicle light-adjusting system 101 is not particularly limited. For example, the vehicle light-adjusting system 101 may be started by an occupant operating an operation unit such as a switch.

1. A light-adjusting system of a vehicle including a window glass capable of adjusting light transmittance, the light-adjusting system comprising:
an interior sensor that detects interior data for grasping a state of an interior of the vehicle;
an interior information acquiring unit that acquires information related to the state of the interior based on the interior data detected by the interior sensor;
a determination unit that determines whether or not the interior is in an abnormal state based on the information acquired by the interior information acquiring unit; and
an adjustment unit that adjusts the light transmittance of the window glass, wherein
when it is determined as the abnormal state by the determination unit in a case where the light transmittance of the window glass has been adjusted to a state in which the interior is difficult to visually recognize from outside the vehicle through the window glass, the adjustment unit adjusts the light transmittance of the window glass to a state in which the interior is easy to visually recognize from outside the vehicle through the window glass.

2. The light-adjusting system according to claim 1, wherein
the window glass is subdivided into a plurality of areas and the light transmittance is adjustable for each of the areas, and
when it is determined as the abnormal state by the determination unit, the adjustment unit adjusts the light transmittance of the window glass so that a warning display including at least one of characters, graphics, and symbols is displayed on the window glass by adjusting the light transmittance of each of the areas.

3. The light-adjusting system according to claim 1, wherein the interior sensor includes at least an occupant sensor that detects occupant data for estimating a state of an occupant.

4. The light-adjusting system according to claim 2, wherein the interior sensor includes at least an occupant sensor that detects occupant data for estimating a state of an occupant.

5. A vehicle light-adjusting system comprising,
an incident portion which an external light enters;
a light-adjusting member arranged in the incident portion;
a light emitting unit provided in an interior of a vehicle; and
a control unit that controls transmittance of the light-adjusting member and controls illuminance of the light emitting unit.

6. The vehicle light-adjusting system according to claim 5, further comprising an information acquiring unit that acquires information on a predetermined object in the vehicle interior, wherein
the control unit adjusts the transmittance of the light-adjusting member and adjusts the illuminance of the light emitting unit based on the information acquired by the information acquiring unit.

7. The vehicle light-adjusting system according to claim 6, wherein
when a state of the predetermined object obtained from the information is determined to be caused by brightness of the interior being lower than a first threshold value defined in advance, the control unit controls the illuminance of the light emitting unit to be higher than a current state, and
when a state of the predetermined object obtained from the information is determined to be caused by brightness of the interior being higher than a second threshold value defined in advance, the control unit controls the transmittance of the light-adjusting member to be lower than a current state.

8. The vehicle light-adjusting system according to claim 6, wherein the information is at least one selected from a group consisting of brightness of the predetermined object, temperature of the predetermined object, number of blinks, and diameter of a pupil of an eye.

9. The vehicle light-adjusting system according to claim 7, wherein the information is at least one selected from a group consisting of brightness of the predetermined object, temperature of the predetermined object, number of blinks, and diameter of a pupil of an eye.

10. The vehicle light-adjusting system according to claim 6, wherein
the predetermined object is a plurality of occupants,
the information acquiring unit acquires individual information on each of the occupants, and
the control unit adjusts the transmittance of the light-adjusting member and adjusts the illuminance of the light emitting unit so that brightness of an individual predetermined area of the occupant becomes a predetermined illuminance.

11. The vehicle light-adjusting system according to claim 7, wherein
the predetermined object is a plurality of occupants,
the information acquiring unit acquires individual information on each of the occupants, and
the control unit adjusts the transmittance of the light-adjusting member and adjusts the illuminance of the light emitting unit so that brightness of an individual predetermined area of the occupant becomes a predetermined illuminance.

12. The vehicle light-adjusting system according to claim 8, wherein
the predetermined object is a plurality of occupants,
the information acquiring unit acquires individual information on each of the occupants, and
the control unit adjusts the transmittance of the light-adjusting member and adjusts the illuminance of the light emitting unit so that brightness of an individual predetermined area of the occupant becomes a predetermined illuminance.

13. The vehicle light-adjusting system according to claim 9, wherein
the predetermined object is a plurality of occupants,
the information acquiring unit acquires individual information on each of the occupants, and
the control unit adjusts the transmittance of the light-adjusting member and adjusts the illuminance of the light emitting unit so that brightness of an individual predetermined area of the occupant becomes a predetermined illuminance.
